(19) United States
(12) Patent Application Publication
(10) Pub. No.: US 2026/0188601 A1
(43) Pub. Date: Jul. 2, 2026

(54) FUSE AND MANUFACTURING METHOD THEREOF

(71) Applicant: ADLER Elektrotechnik DongGuan Co., Ltd., Dongguan (CN)

(72) Inventors: Lin Gao, Dongguan (CN); Liguang Li, Dongguan (CN); Xiaobo Li, Dongguan (CN); Meijuan Lei, Dongguan (CN)

(21) Appl. No.: 19/313,944

(22) Filed: Aug. 29, 2025

(30) Foreign Application Priority Data
Dec. 30, 2024 (CN) 202411968962.6

(51) Int. Cl. H01H 85/143; H01H 69/02; H01H 85/00; H01H 85/044; H01H 85/175; H01H 85/18

(52) U.S. Cl. CPC H01H 85/143; H01H 69/02; H01H 85/003; H01H 85/044; H01H 85/175; H01H 85/18

(57) ABSTRACT

A fuse and a manufacturing method thereof, the fuse including: a tube body; a fuse element disposed inside the tube body; two inner caps respectively disposed at two ends of the tube body, the inner caps being electrically connected to the fuse element; and two flexible terminals sleeving over the inner caps and electrically connected to the inner caps, the flexible terminals being capable of deforming under an external force. In the present disclosure, when the flexible terminals are connected to external cables, the flexible terminals are capable of deforming to conform to the external cables, thereby improving a reliability of connection between the external cables and the fuse, reducing impedance between the external cables and the fuse, and preventing abnormal disconnection of the fuse.

### CROSS-REFERENCE TO RELATED APPLICATION

The present disclosure claims the benefit of Chinese patent application No. 202411968962.6, filed on Dec. 30, 2024, which is incorporated herein by reference in its entirety.

### TECHNICAL FIELD

The present disclosure relates to the field of electrical protection, and in particular to a fuse and a manufacturing method thereof.

### BACKGROUND

For fuses that require flexible wiring, when connecting external cables, the wiring terminals of the fuses are relatively rigid, so that even if the external cables are crimped, there is also a problem of insufficient reliability of connection, resulting in high impedance between the external cables and the fuse, which can easily cause abnormal disconnection of the fuse.

### SUMMARY

An objective of the present disclosure is to provide a fuse and a manufacturing method thereof, which can improve a reliability of connection between an external cable and the fuse and reduce impedance between the external cable and the fuse.

To achieve the above objective, the present disclosure provides a fuse, including:
a tube body;
a fuse element disposed inside the tube body;
two inner caps respectively disposed on two ends of the tube body, where the inner caps are electrically connected to the fuse element;
two flexible terminals sleeving over the inner caps and electrically connected to the inner caps, where the flexible terminals are allowed to deform under an external force.

In some embodiments of the present disclosure:
Each of the flexible terminals includes a first connection part and a connecting part, the first connection part is connected to the connecting part, the first connection part sleeves over one of the inner caps, the connecting part is configured to connect an external cable, and both the connecting part and the first connection part are allowed to deform under the external force.

In some embodiments of the present disclosure:
Each of the flexible terminals further includes a waterproof plug, both the connecting part and the first connection part are tubular, the waterproof plug is provided at a tube opening, where the connecting part connects to the first connection part, of the connecting part, so that the waterproof plug separates an interior of the connecting part from an interior of the first connection part.

In some embodiments of the present disclosure:
Each of the inner caps is provided with a through hole, and the through hole communicates with an interior of the tube body.

In some embodiments of the present disclosure:
Each of the inner caps includes a second connection part and an extension part, the second connection part is tubular, and the extension part is provided at one end of the second connection part, the extension part extends along a radial direction of the second connection part toward a central axis of the second connection part, the extension part is formed with the through hole, the second connection parts of the inner caps sleeve respectively on an outer peripheral surface of the tube body at the two ends of the tube body, and the extension part is located between the tube body and one of the flexible terminals.

In some embodiments of the present disclosure:
Two ends of the fuse element are respectively welded to the inner caps respectively disposed on the two ends of the tube body to form electrical connections between the inner caps and the fuse element.

In some embodiments of the present disclosure, the fuse further includes:
two gaskets, the gaskets are disposed inside the flexible terminals respectively, where end surfaces, at sides facing away from the tube body, of the inner caps, and inner walls of the flexible terminals jointly press against the gaskets, and each of the gaskets covers the through hole of the inner caps.

In some embodiments of the present disclosure:
The flexible terminals are made of red copper.

In some embodiments of the present disclosure:
The tube body is filled therein with a protective filler.

The present disclosure further provides a manufacturing method of the above-mentioned fuse, including following steps:
S1, selecting the tube body, and inserting the fuse element into the tube body;
S2, mounting the inner caps on the two ends of the tube body respectively;
S3, welding the two ends of the fuse element to the inner caps respectively;
S4, crimping the flexible terminals onto the inner caps respectively.

Compared with the prior art, the present disclosure provides a fuse and a manufacturing method thereof, which have following beneficial effects:
The fuse of the present disclosure includes a tube body, a fuse element, inner caps, and flexible terminals sleeving over the inner caps, and the flexible terminals are electrically connected to the inner caps and are capable of deforming under an external force. When the flexible terminals are connected to external cables, the flexible terminals are capable of deforming to conform to the external cables, thereby improving a reliability of connection between the external cables and the fuse, reducing impedance between the external cables and the fuse, and preventing abnormal disconnection of the fuse.

The manufacturing method of the fuse of the present disclosure is used to manufacture the aforementioned fuse, which improves the reliability of connection between the external cables and the fuse, reduces the impedance between the external cables and the fuse, and prevents abnormal disconnection of the fuse.

### BRIEF DESCRIPTION OF THE DRAWINGS

FIG. 1 is a schematic structural diagram of a fuse according to an embodiment of the present disclosure;

FIG. 2 is a schematic exploded view of the fuse according to the embodiment of the present disclosure;

FIG. 3 is a schematic diagram illustrating a connection between inner caps and a fuse element according to the embodiment of the present disclosure;

FIG. 4 is a schematic structural diagram of a tube body according to the embodiment of the present disclosure;

FIG. 5 is a schematic structural diagram of the fuse element according to the embodiment of the present disclosure;

FIG. 6 is a schematic structural diagram of an inner cap according to the embodiment of the present disclosure;

FIG. 7 is an exploded view of a flexible terminal according to the embodiment of the present disclosure;

FIG. 8 is schematic diagram of the flexible terminal of FIG. 7 viewed in another direction;

FIG. 9 is a sectional view of a flexible terminal according to another embodiment of the present disclosure;

FIG. 10 is a sectional view of a waterproof plug in FIG. 9;

FIG. 11 is a sectional view of a flexible terminal according to a further embodiment of the present disclosure;

FIG. 12 is a sectional view of a waterproof plug in FIG. 11.

In the figures: 100, fuse; 1, tube body; 2, fuse element; 3, inner cap; 4, flexible terminal; 5, gasket; 31, through hole; 32, second connection part; 33, extension part; 41, first connection part; 42, connecting part; 43, waterproof plug; 411, sealing groove; 431, supporting part; 432, sealing part.

### DETAILED DESCRIPTION

Specific embodiments of the present disclosure are further described in detail below with reference to the accompanying drawings and embodiments. The following embodiments are used to illustrate the present disclosure, but are not intended to limit the scope of the present disclosure.

In the description of the present disclosure, it should be noted that terms “center”, “longitudinal”, “transverse”, “upper”, “lower”, “front”, “rear”, “left”, “right”, “vertical”, “horizontal”, “top”, “bottom”, “inside”, “outside”, etc., indicates directions or positions based on the directions or positions shown in the accompanying drawings. And the terms are merely used to facilitate description of the present disclosure and simplify the description, rather than indicating or implying that the device or element referred to must have a specific direction, or be constructed and operated in a specific direction, and therefore the terms cannot be understood as a limitation to the present disclosure. In addition, terms “first”, “second”, “third”, and the like, are used for descriptive purposes only and cannot be understood as indicating or implying relative importance.

In the description of the present disclosure, it should be noted that the terms “mount”, “communication” and “connection” should be understood in a broad sense unless expressly specified and limited otherwise. For example, these terms mean a fixed connection, a detachable connection, or an integral connection; mean a mechanical connection or an electrical connection; and mean a direct connection, indirect connection via an intermediate medium, or a communication of interiors of two elements. For those of ordinary skill in the art, the specific meanings of the above terms in the present disclosure may be understood according to specific situations.

In addition, in the description of the present disclosure, unless otherwise specified, the term “a plurality of” means two or more.

For those of ordinary skill in the art, the specific meanings of the above terms in the present disclosure may be understood according to specific situations.

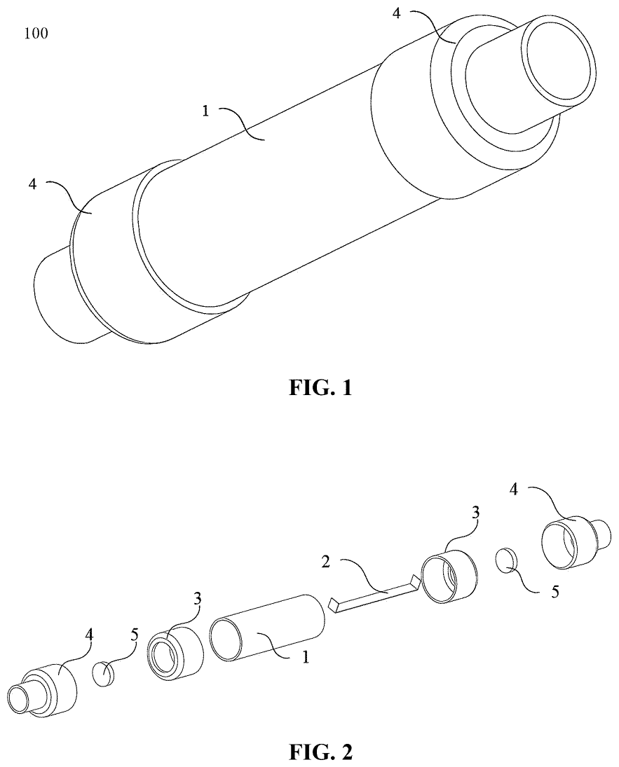

Referring to FIG. 1 and FIG. 2, a fuse 100 according to an embodiment of the present disclosure, includes: a tube body 1, a fuse element 2, inner caps 3, and flexible terminals 4.

Referring to FIG. 4, the tube body 1 is an insulating tube.

Referring to FIG. 5, the fuse element 2 is disposed inside the tube body 1.

The inner caps 3 are disposed on two ends of the tube body 1 respectively, and the inner caps 3 are electrically connected to the fuse element 2. The inner caps 3 are made of conductive material.

The flexible terminal 4 sleeves over and is electrically connected to the inner cap 3. The flexible terminal 4 is capable of deforming under an external force.

In this embodiment, when the flexible terminal 4 is connected to an external cable, the flexible terminal 4 is capable of deforming to conform to the external cable, thereby improving a reliability of connection between the external cable and the fuse 100, reducing impedance between the external cable and the fuse 100, and preventing abnormal disconnection of the fuse 100.

The flexible terminals 4 are made of conductive material. In this embodiment, the flexible terminal 4 needs to possess an ability to deform while also achieving electrical connection with the inner cap 3, i.e., possessing conductivity. The flexible terminal 4 may be made of red copper to meet requirements for deformation and conductivity of the flexible terminal 4. Through repeated research and testing, the flexible terminal made of red copper possess both excellent conductivity and excellent flexible connection performance, which can meet the requirements for flexible connections of the fuse 100 in many application scenarios. Of course, the flexible terminal 4 can also be made of other materials with similar properties to red copper.

Referring to FIG. 7 and FIG. 8, the flexible terminal 4 includes a first connection part 41 and a connecting part 42, the first connection part 41 is connected to the connecting part 42, and the first connection part 41 sleeves over the inner cap 3. The connecting part 42 is configured to connect the external cable, and both the connecting part 42 and the first connection part 41 are capable of deforming under the external force.

The flexible terminal 4 and the inner cap 3 are in an interference fit. The first connection part 41 is configured to connect the inner cap 3. The first connection part 41 is capable of deforming, such that when the first connection part 41 sleeves over the inner cap 3, the first connection part 41 deforms to clamp an outer wall of the inner cap 3, thereby achieving the connection between the flexible terminal 4 and the inner cap 3. Additionally, since the inner cap 3 and the first connection part 41 are in contact with each other, an electrical connection may also be formed between them.

The connecting part 42 is configured to connect the external cable. The connecting part 42 is capable of deforming, so that when the external cable is inserted into the connecting part 42, the connecting part 42 deforms to clamp the external cable, which makes the connecting part 42 more closely conform to the external cable, thereby achieving the connection between the connecting part 42 and the external cable, improving the reliability of connection between the external cable and the fuse 100, reducing the impedance between the external cable and the fuse 100, and preventing abnormal disconnection of the fuse 100.

In this embodiment, the flexible terminal 4 further includes a waterproof plug 43. Both the connecting part 42 and the first connection part 41 are tubular, and the waterproof plug 43 is provided at a tube opening, where the connecting part 42 connects to the first connection part 41, of the connecting part 42, so that the waterproof plug 43 separates an interior of the connecting part 42 from an interior of the first connection part 41.

The waterproof plug 43 is also capable of deforming. After the waterproof plug 43 is inserted, the interior of the connecting part 42 is isolated from the interior of the first connection part 41, and external water vapor cannot enter an interior of the fuse 100 from the connecting part 42, thereby achieving a waterproof effect. The waterproof plug 43 is made of insulating material, such as silica gel.

Specifically, a sealing groove 411 is provided at a tube opening of the first connection part 41 where the first connection part 41 connects to the connecting part 42. The sealing groove 411 surrounds the tube opening of the connecting part 42. A part of the waterproof plug 43 is disposed in the sealing groove 411, and another part of the waterproof plug 43 extends into the interior of the connecting part 42.

With the structure above, sufficient contact area between the waterproof plug 43 and an interior of the flexible terminal 4 can be ensured, thereby ensuring the waterproof effect.

In other embodiments, a waterproof plug 43 with a different structure may also be used.

The waterproof plug 43 includes a supporting part 431 and a sealing part 432, the sealing part 432 is at least disposed on a part of a surface of the supporting part 431. At least a part of the sealing part 432 is inserted into the sealing groove 411.

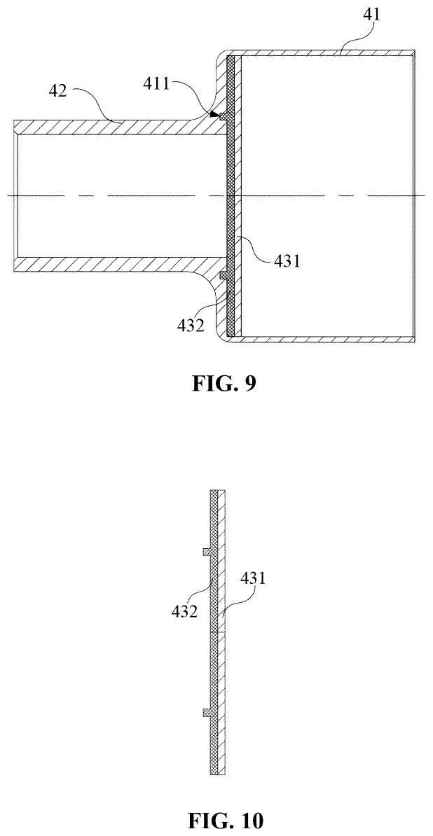

Specifically, referring to FIG. 9 and FIG. 10, the supporting part 431 may be sheet-shaped, and the sealing part 432 may be sheet-shaped similar to the supporting part 431. The sealing part 432 and the supporting part 431 are stacked together. A side surface of the sealing part 432 facing away from the supporting part 431 is provided with a ring-shaped protrusion which is inserted into the sealing groove 411. The sealing part 432 plays a role in sealing, and the supporting part 431 provides strength to the waterproof plug 43.

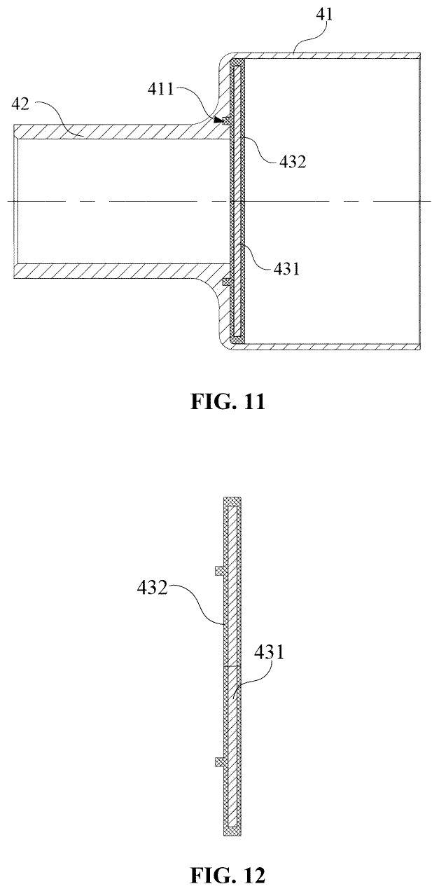

Alternatively, referring to FIG. 11 and FIG. 12, the supporting part 431 is sheet-shaped, and the sealing part 432 wraps the supporting part 431. A side surface of the sealing part 432 is provided with a ring-shaped protrusion which is inserted into the sealing groove 411. The sealing part 432 plays the role in sealing, and the supporting part 431 provides strength to the waterproof plug 43.

The supporting part 431 may be a metal sheet, such as a copper sheet. A main function of the supporting part is to play a role of supporting, thus, so long as a material with a certain strength may be used for making the supporting part, and it is not necessary to be limited to a metal material or a conductive material, or a non-conductive material may be selected. The sealing part 432 is made of insulating material, for example, silica gel. The supporting part 431 and the sealing part 432 may be connected together through methods such as adhesive bonding or injection molding.

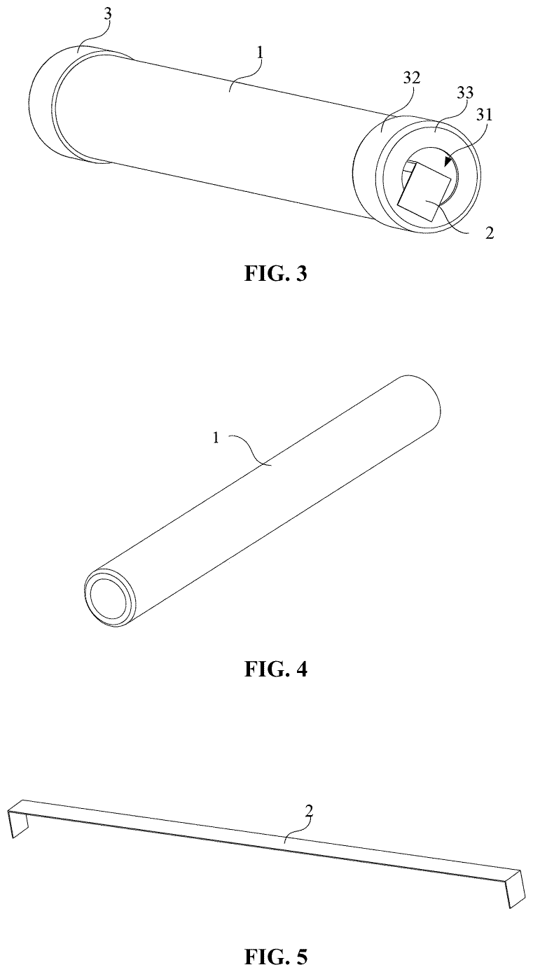

In this embodiment, referring to FIG. 3, two ends of the fuse element 2 are respectively welded to the respective inner caps 3 on the two ends of the tube body 1 to form electrical connections between the inner caps 3 and the fuse element 2.

The welding of the fuse element 2 to the inner caps 3 allows the inner caps 3 and the fuse element 2 to be connected as a whole, thereby reducing impedance caused by an assembly of the fuse element 2 and the inner caps 3.

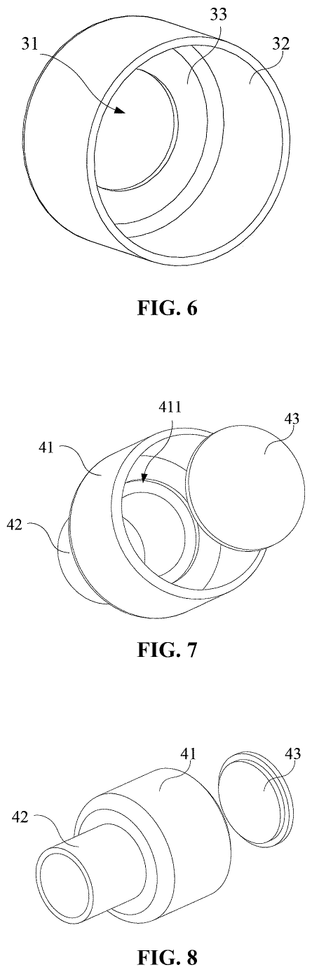

Referring to FIG. 6, the inner cap 3 is provided with a through hole 31, which communicates with an interior of the tube body 1.

When assembling the fuse 100, the through hole 31 facilitates positioning of the fuse element 2 inside the tube body 1, thereby facilitating the welding of the fuse element 2 to the inner caps 3.

In this embodiment, the inner cap 3 includes a second connection part 32 and an extension part 33. The second connection part 32 is tubular, and the extension part 33 is provided at one end of the second connection part 32. The extension part 33 extends along a radial direction of the second connection part 32 toward a central axis of the second connection part 32, and is formed with the through hole 31. The second connection parts 32 of the inner caps 3 sleeve respectively on an outer peripheral surface of the tube body 1 at the two ends of the tube body 1. The extension part 33 is located between the tube body 1 and the flexible terminal 4, and the fuse element 2 is welded to the extension part 33.

The second connection part 32 is configured to connect the inner cap 3 to the tube body 1. The extension part 33 is capable of partially covering tube openings at the two ends of the tube body 1. The extension part 33 provides a welding position for the fuse element 2. The through hole 31 formed in the extension part 33 facilitates the positioning of the fuse element 2 inside the tube body 1, thereby facilitating the welding of the fuse element 2 to the inner caps 3.

In this embodiment, the tube body 1 is filled therein with a protective filler.

The protective filler is quartz sand, which is capable of cooling and quenching an electric arc during the use of the fuse 100.

The fuse 100 in this embodiment further includes gaskets 5, which are disposed inside the respective flexible terminals 4. An end surface of the inner cap 3 at a side of the inner cap 3 facing away from the tube body 1 and an inner wall of the flexible terminal 4 jointly press against one of the gaskets 5, and the one of the gaskets 5 covers the through hole 31.

Each of the gaskets 5 allows for a tighter connection between the flexible terminal 4 and the inner cap 3 after the flexible terminal 4 is mounted on the inner cap 3, thereby enhancing a connection stability between flexible terminal 4 and inner cap 3. Additionally, each of the gaskets 5 covers the through hole 31, preventing the protective filler in the tube body 1 from spilling out through the through hole 31. During the use of the fuse 100, the gaskets 5 may also work with the protective filler to quench the electric arc. The gaskets 5 are made of insulating material.

This embodiment also provides a manufacturing method of the above-mentioned fuse 100, including following steps:
S1, selecting the tube body 1, and inserting the fuse element 2 into the tube body 1;
S2, mounting the inner caps 3 on the two ends of the tube body 1 respectively, and forming electrical connections between the inner caps 3 and the fuse element 2;
Specifically, first mounting the inner caps 3 on the two ends of the tube body 1 respectively, then welding the two ends of the fuse element 2 to the respective inner caps 3 to form the electrical connections between the inner caps 3 and the fuse element 2;
S3, crimping the flexible terminals 4 to the respective inner caps 3;
Specifically, crimping the flexible terminal 4, at one end of the tube body 1, to the inner cap 3 corresponding thereto, filling the tube body 1 with the protective filler, and then crimping the flexible terminal 4, at the other end of the tube body 1, to the inner cap 3 corresponding thereto.

The manufacturing method of the fuse according to this embodiment is configured to manufacture the above-mentioned fuse, which improves the reliability of connection between the external cables and the fuse, reduces the impedance between the external cables and the fuse, and prevents abnormal disconnection of the fuse.

The above are only preferred embodiments of the present disclosure. It should be noted that, for a person of ordinary skill in the art, several improvements and replacements may be made without departing from the technical principle of the present disclosure, and such improvements and replacements should also be considered within the protection scope of the present disclosure.

1. A fuse, comprising:
a tube body;
a fuse element disposed inside the tube body;
two inner caps respectively disposed on two ends of the tube body, wherein the inner caps are electrically connected to the fuse element;
two flexible terminals sleeving over the inner caps and electrically connected to the inner caps, wherein the flexible terminals are allowed to deform under an external force.

2. The fuse according to claim 1, wherein,
each of the flexible terminals comprises a first connection part and a connecting part, the first connection part is connected to the connecting part, and the first connection part sleeves over one of the inner caps, the connecting part is configured to connect an external cable, and both the connecting part and the first connection part are allowed to deform under the external force.

3. The fuse according to claim 2, wherein,
each of the flexible terminals further comprises a waterproof plug, both the connecting part and the first connection part are tubular, the waterproof plug is provided at a tube opening, where the connecting part connects to the first connection part, of the connecting part, so that the waterproof plug separates an interior of the connecting part from an interior of the first connection part.

4. The fuse according to claim 1, wherein,
each of the inner caps is provided with a through hole, and the through hole communicates with an interior of the tube body.

5. The fuse according to claim 4, wherein,
each of the inner caps comprises a second connection part and an extension part, and the second connection part is tubular,
the extension part is provided at one end of the second connection part, the extension part extends along a radial direction of the second connection part toward a central axis of the second connection part, and the extension part is formed with the through hole,
the second connection parts of the inner caps sleeve respectively onto an outer peripheral surface of the tube body at the two ends of the tube body, and the extension part is located between the tube body and one of the flexible terminals.

6. The fuse according to claim 1, wherein,
two ends of the fuse element are respectively welded to the inner caps respectively disposed on the two ends of the tube body to form electrical connections between the inner caps and the fuse element.

7. The fuse according to claim 1, further comprising:
two gaskets disposed inside the flexible terminals, wherein end surfaces, at sides facing away from the tube body, of the inner caps, and inner walls of the flexible terminals jointly press against the gaskets, and the gaskets cover through holes of the inner caps.

8. The fuse according to claim 1, wherein,
the flexible terminals are made of red copper.

9. The fuse according to claim 1, wherein,
the tube body is filled therein with a protective filler.

10. A manufacturing method of the fuse according to claim 1, comprising following steps:
S1, selecting the tube body, and inserting the fuse element into the tube body;
S2, mounting the inner caps on the two ends of the tube body respectively;
S3, welding two ends of the fuse element to the inner caps respectively;
S4, crimping the flexible terminals onto the inner caps respectively.
